(19) United States
(12) Patent Application Publication
(10) Pub. No.: US 2002/0147600 A1
(43) Pub. Date: Oct. 10, 2002

(54) System and method for implementing financial transactions using biometric keyed data

(75) Inventors: Colin A. Waters, Lawrenceville, GA (US); Stephen J. Chasko, Flowery Branch, GA (US)

Correspondence Address: Paul W. Martin, NCR Corporation, Law Department, ECD-2, 101 W. Schantz Avenue, Dayton, OH, 45479-0001, US

(73) Assignee: NCR Corporation

(21) Appl. No.: 09/827,291

(22) Filed: Apr. 5, 2001

(51) Int. Cl. G06F 17/60

(52) U.S. Cl. 705/1

(57) ABSTRACT

A system and method provide access to a consumer's financial account without requiring a token or personal identifier. The system includes a biometric data capture device for capturing biometric data corresponding to the consumer. The biometric data is sent to a merchant payment host where it is used to generate a data storage key. Data records in an identity database are stored in the database by using keys generated from biometric data contained in the records. The biometric data contained in the records is obtained from consumers responsible for financial accounts maintained by the merchant payment host. When the merchant payment host locates a record in the database that corresponds to the key generated from the received biometric data, the host compares the received biometric data to the biometric data stored in the retrieved record. Correspondence between the two sets of data confirms the existence of a financial account for the consumer managed by the host and processing of a transaction may proceed. Security of the transaction is further enhanced by generating a digital signature from the biometric data for purposes of verifying a consumer approved transaction message.

### FIELD OF THE INVENTION

This invention relates generally to methods and systems for implementing financial transactions and, more particularly, to methods and systems for implementing financial transactions using biometric data.

### BACKGROUND OF THE INVENTION

Financial transactions systems are typically used to provide a consumer with access to funds for a purchase of some sort. Many financial transaction systems are token based as they require the consumer to submit a token, usually in the form of a credit, debit, or smart card, that identifies a financial account associated with the consumer. A terminal associates the financial account data and the customer data stored in the token with transaction data to generate a transaction message. The transaction message is then transmitted via a communication network to a host system that validates the association of the account and customer data and generates an authorization message for the transaction. The authorization message is returned to the terminal and the terminal indicates whether the host system approved the transfer of funds from the account associated with the consumer to the entity from which the consumer is making a purchase. If the transaction is approved, the consumer acknowledges the transaction approval and receives the goods or services.

Fraudulent transactions may occur when a token is stolen from a consumer or when valid account data is used to produce a counterfeit token. The person attempting to defraud an entity regarding a purchase presents the token and masquerades as the person associated with the account data stored in the token. This type of fraud most frequently occurs with credit cards because debit cards require the use of a personal identification number (PIN) to validate the association between the person presenting the card and the card. Personal data stored in the memory of a smart card may be used to validate the association in an even more exacting manner. Despite the use of PINs or other data to validate the association, methods for obtaining such association validation data have been developed by defrauders and used to perpetrate fraudulent transactions.

In an effort to frustrate persons attempting to defraud establishments in financial transactions, systems and methods for implementing financial systems have been developed that do not require tokens. Systems of this type are described in U.S. Pat. Nos. 5,870,723; 5,764,789; 5,838,812, all to Pare, Jr. et al., and U.S. Pat. No. 6,045,039 to Stinson et al. These systems require a consumer to provide biometric data along with a consumer identifier, such as a PIN, to implement a financial transaction. The biometric data is an image scan of the consumer's face, fingerprint, retina, or the like to generate a set of data that uniquely identifies the consumer. This data set is then transmitted with the consumer identifier to a host system. The host system then uses the consumer identifier as a key to retrieve a database record that contains a set of biometric data corresponding to the person associated with a financial account also identified by the record. By comparing the set of biometric data received from the transaction location to the set of biometric data stored in the data record, the host system determines whether the person attempting to purchase goods and/or services is the person associated with the account stored in the data record. If the two sets of data are equivalent, the transaction is approved and the merchant is permitted to generate a message for the transfer of funds from the consumer's account to a merchant account. Otherwise, the transaction is not approved.

While these systems are an improvement over token systems, they still require the consumer to provide an identifier that is used as a key for the retrieval of the consumer's biometric and account data. Thus, the consumer must memorize the consumer identifier or keep a record to facilitate the consumer's recollection of the identifier for transactions. Furthermore, the consumer would be required to memorize or maintain a record of multiple consumer identifiers for different financial accounts managed by different host systems because each host system would use a different key to store biometric data of a consumer. Multiple consumer identifiers would be avoided if a common biometric validation system was used to confirm the association of a set of biometric data with a financial account and then forward the transaction data and account data to the financial account host system for processing. However, the cost of operating the common validation system would be added to the transactions charges of the host financial systems and the management of the biometric data sets for all of the consumers having financial accounts with a plurality of financial host systems may be prohibitive.

Consequently, what is needed is a financial transaction system that does not require a consumer to have a token or a consumer identifier to support a transaction.

What is needed is a financial transaction system that does not require a consumer to have a consumer identifier for each financial account maintained by a consumer.

What is needed is a financial transaction system that does not require a common validation system for confirming association of a set of biometric data to a financial account before forwarding transaction and account data to a financial account host for processing.

### SUMMARY OF THE INVENTION

The above-noted limitations of previously known systems and methods for implementing financial transactions have been overcome by a system and method that operate in accordance with the principles of the present invention. The method of the present invention includes generating a data storage key from a set of biometric data corresponding to a consumer and retrieving a data record corresponding to the data storage key and the record contains customer financial account data. By using a data storage key generated from a set of biometric data corresponding to a consumer to retrieve a data record containing financial account data for the consumer, no identifying information other than the biometric data corresponding to the person need be provided for a financial transaction.

The method may be implemented with a system made in accordance with the principles of the present invention. The system includes a biometric data capture device for reading consumer biometric data and a database server for generating a data storage key from the consumer biometric data received from the biometric data capture device and for retrieving a data record corresponding to the generated data storage key. The database of the database server is built with data records containing a set of biometric data for a consumer and financial account data associated with the consumer. The biometric data is acquired from a consumer at the time that the consumer applies for a financial account with the financial institution that operates the database server. Upon approval of the application and the generation of the financial account data, a data storage key generator uses the biometric data to generate a data storage key that is used to store the data record in the database. Preferably, the database server is maintained by a host financial system at a location coupled to financial transaction terminals at a plurality of merchant locations. A scanner for capturing biometric data from a consumer is coupled to each financial transaction terminal. The captured biometric data is used to generate an account verification message that is sent to the database server maintained by the financial host system. The database server retrieves the data record stored in the database by using a data storage key generated from the captured biometric data. Biometric data stored in the retrieved data record is compared to the captured biometric data to determine whether the consumer at the financial transaction terminal corresponds to the consumer associated with the financial account data stored in the data record. If the two sets of biometric data correspond to one another, the financial account data is sent to the terminal so the consumer may request transaction authorization. The request is generated from transaction data entered at the terminal. If the request is approved, the terminal generates a transaction record for the merchant and the consumer. Additionally, the host system generates a funds transfer message to effect the transfer of funds from the consumer's financial account to an account associated with the merchant.

It is an object of the present invention to provide a consumer access to a financial account without requiring consumer identification other than biometric data corresponding to the consumer.

These and other advantages and features of the present invention may be discerned from reviewing the accompanying drawings and the detailed description of the invention.

### BRIEF DESCRIPTION OF THE DRAWINGS

The present invention may take form in various system and method components and arrangement of system and method components. The drawings are only for purposes of illustrating an exemplary embodiment and are not to be construed as limiting the invention.

FIG. 1 depicts a block diagram of a system that may be used to verify the association of a consumer and a financial account through corresponding biometric data;

FIG. 2A is a flowchart of an exemplary method for generating a data record for the identity database of FIG. 1; and

FIG. 2B is a flowchart of an exemplary method for implementing a financial transaction that uses the corresponding biometric data of a consumer to verify authorization for financial account access.

### DETAILED DESCRIPTION OF THE INVENTION

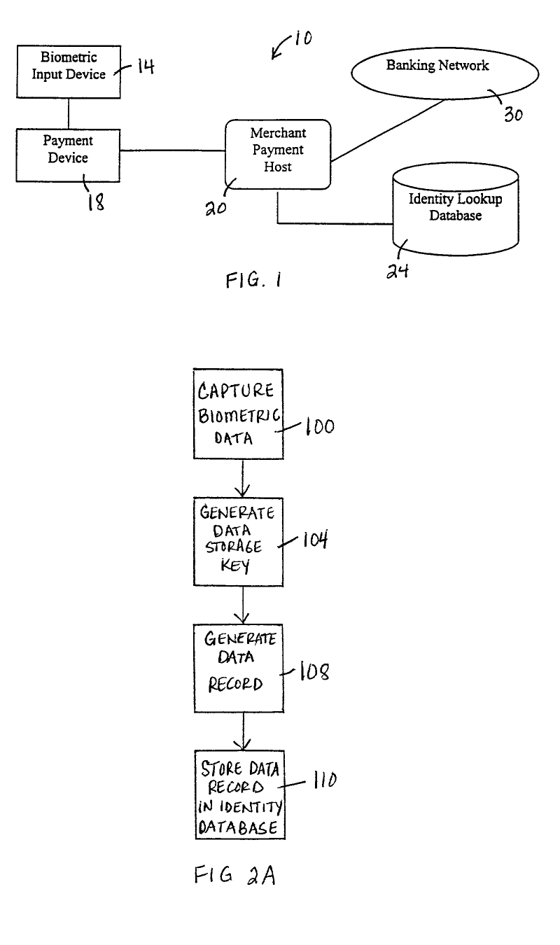

A system embodying the present invention is shown in FIG. 1. System 10 may include a biometric input device 14, a payment device 18, a merchant payment host 20, an identity lookup database 24, and a clearinghouse network 30. Input device 14 and payment device 18 may be located at a point of purchase site for a merchant. Input device 14 may be any known biometric data scanner such as a fingerprint imager, a retina scanner, a photographic device, a voice print device, a signature capture device, or the like. Payment device 18 may be a point-of-sale (POS) terminal, a credit card terminal, or other computer implemented device in which transaction data may be entered and stored. Preferably, input device 14 is coupled to payment device 18 that is, in turn, coupled to merchant payment host 20. Alternatively, input device 14 may be coupled to host 20 without communicating through device 18. Host 20 may be coupled to payment device 18 and input device 14 through an open network, such as the internet, a proprietary WAN or LAN network, or through a point-to-point communication system, such as the public switched telephone network (PSTN). Host 20 includes a database server that manages database 24. The database server and database may be a relational database system or an object repository system. Clearinghouse network 30 may be any known financial clearinghouse network used to communicate electronic funds transfer (EFT) messages between financial institutions.

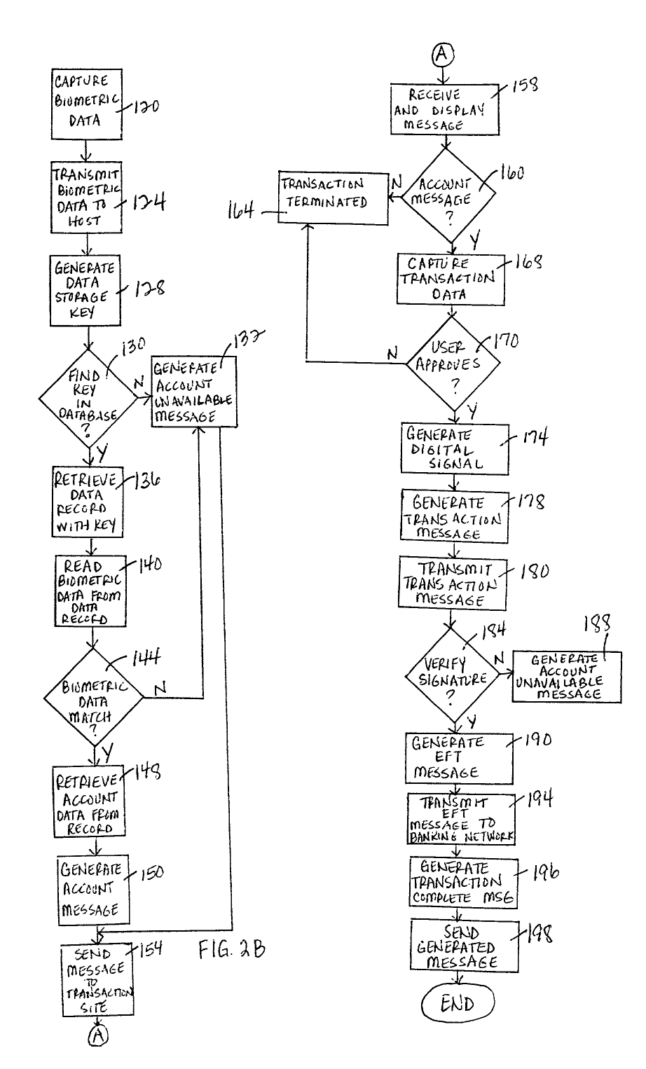

The data records of database 24 are organized for retrieval by data storage keys, in a relational database, or object identifiers, in an object repository, that correspond to the biometric data for a consumer. A process of generating data records for identity database 24 is described with reference to FIG. 2A. At the time that a consumer applies for a financial account with a merchant payment host, a biometric data capture device is used to obtain biometric data from the consumer (Block 100). To provide a key for retrieval of the data record, the biometric data is input to a hashing function or the like to generate a data storage key (Block 104). The hashing function may be any algorithm that maps all or selected portions of the biometric data to the output domain of the hashing function. For example, human fingerprint data includes points of bifurcation and termination. Bifurcation points are where ridges of a fingerprint meet and termination points are where ridges terminate according to a minutia based algorithm. The number of bifurcation points and termination points along with geometric data regarding location of the points for an individual's fingerprint may be combined to generate a key that is statistically unique for that individual. Another example of key generation uses data acquired from the capture of a person's signature. In this case, the signature capture device captures a signature and related data for generation of the signature such as pressure variation points in the signature and/or acceleration data for strokes in the signature. These data may be used with the name of the signature to generate a primary key for a person's data records.

In an alternative embodiment, name data obtained from signature acquisition data may be used to generate a key for retrieving data records. Although name data does not necessarily generate a unique key for a person's records, it does narrow the number of records retrieved in response to a query using the name key. The biometric data received from the merchant purchase site may then be compared to the biometric data stored in each of the records. If any such comparison indicates the received biometric data corresponds to the stored biometric data then the transaction may continue. Otherwise, the merchant payment host indicates that the person at the merchant purchase site does not correspond to an authorized payment account.

Once the consumer is approved for an account and the account data, such as account number and transaction limits, are generated, a data record for the consumer may be generated (Block 108). The biometric data corresponding to the consumer is stored in the data record with the account data and the data record is stored in database 24 (Block 110).

Once database 24 has been populated with a data record for a consumer, the consumer may obtain access to the financial account through the presentation of biometric data corresponding to the consumer. An exemplary process for processing such a transaction is shown in FIG. 2B. At the transaction site, a consumer cooperates with some biometric device so biometric data corresponding to the consumer may be obtained (Block 120). The biometric data may then be transmitted in an account verification message to merchant host 20 (Block 124). Merchant host 20 then generates a data storage key from the biometric data using the function by which it generated the keys for the records stored in database 24 (Block 128). Database 24 is then queried for a data record corresponding to the generated data storage key (128). If the key is not found, an error message indicating a financial account is not available for the consumer is generated (Block 132). Otherwise, the corresponding data record is retrieved (Block 136) and the biometric data stored in the record is read (Block 140). If the biometric data received from the transaction site corresponds to the biometric data of the retrieved record (Block 144), the financial account data of the retrieved data record is read (Block 148) and used to generate an account message (Block 150). Otherwise, an error message is generated (Block 132). The account message preferably identifies the consumer's financial account and available balance or transaction limit. A message is then returned to the transaction site (Block 154).

At the transaction site, payment device 18 receives and displays some of the data of the account message or the account unavailable message (Block 158). If the account unavailable message is displayed (Block 160), the transaction is terminated (Block 164). Otherwise, transaction data is captured (Block 168) and displayed on payment device 18 so the consumer may determine whether to proceed with the transaction in view of the account data. If the user does not approve the transaction (Block 170), the transaction is terminated (Block 164). If the user approves the transaction, a digital signature is generated from the biometric data using a digital signature key (Block 174). A transaction message is then generated (Block 178) and transmitted to host 20 (Block 180). The transaction message includes the transaction amount along with the account data and the digital signature.

At host 20, a digital signature is generated from the biometric data in the retrieved data record and a signature key. The signature generated at host 20 is then compared to the signature received in a transaction message (Block 184) and, if they do not correspond, an account unavailable message is generated (Block 188). If the two signatures correspond, an electronic funds transfer (EFT) message is generated to transfer funds from the consumer's financial account to one associated with the merchant at the transaction site (Block 190). The EFT message is then transmitted onto banking network 30 (Block 194). Host 20 generates a transaction complete message (Block 196) and transmits it to payment device 18 (Block 198). Payment device 18 may then display the message so the consumer may update records regarding the financial account. The updating may be by written record or the consumer may have a smart card or personal digital assistant that may receive the data via an electrical connection, such as a cable or the like, or by a wireless method, such as an infrared link. Preferably, the transaction complete message includes a transaction number so the transaction may be identified in the consumer's records.

The system and method of the present invention enable a consumer to access a financial account managed by a merchant payment host without any token or data other than biometric data corresponding to the consumer. This system and method alleviates the need for the consumer to keep records on his or her person regarding access numbers or other data for authenticating access to the account. The system and method of the present invention not only advantageously uses the uniqueness of biometric data for security purposes but for data storage benefits as well. Because the biometric data may be used to generate storage keys or object identifiers that uniquely identify data records for a consumer, a consumer need not know financial account identifiers and PINs. Consequently, this information is less publicly available and the security of the consumer's financial account is further enhanced.

While the present invention has been illustrated by the description of exemplary processes, and while the various processes have been described in considerable detail, it is not the intention of the applicant to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A system for providing consumer access to a financial account to implement a transaction comprising:
a biometric data capture device for reading consumer biometric data; and
a database server for generating a data storage key from the consumer biometric data received from the biometric data capture device and for retrieving a data record corresponding to the generated data storage key.

2. The system of claim 1 further comprising:
a payment device coupled to said biometric data capture device, said payment device generating a digital signature from said biometric data for a transaction message.

3. A system for supporting consumer access to a financial account by means of biometric data solely comprising:
a biometric data capture device for capturing biometric data corresponding to a consumer; and
a payment device for sending said captured biometric data to a merchant payment host as the identifier for the consumer's financial account data.

4. The system of claim 2 wherein said payment device generates a digital signature from said captured biometric data.

5. The system of claim 1 wherein the generated key is name data and the database server retrieves a plurality of data records corresponding to the generated key and determines whether biometric data stored in any of the retrieved data records corresponds to other biometric data received from a merchant purchase site.

6. A system for verifying access to a consumer's financial account comprising:
a database server for generating a data storage key from biometric data received from a transaction site; and
an identity database comprised of data records stored with reference to a data storage key corresponding to biometric data contained within the data record so that the database server may retrieve records from the identity database using data storage keys generated from the received biometric data.

7. The system of claim 6 wherein the database server generates a digital signature from biometric data retrieved from the identity database so that a transaction message may be verified.

8. A method for authorizing access to a financial account for a consumer comprising:
generating a data storage key from biometric data corresponding to a consumer; and
retrieving a data record corresponding to the generated data storage key, the data record containing financial account data for the consumer.

9. The method of claim 8 further comprising generating a digital signature from the biometric data corresponding to the consumer to authorize generation of electronic funds transfer messages for a financial transaction.

10. The method of claim 8 further comprising:
capturing the biometric data corresponding to the consumer; and
transmitting the captured biometric data so the data storage key may be generated.

11. The method of claim 9 further comprising comparing the generated digital signature to a received digital signature to authorize generation of electronic funds in response to said generated digital signature corresponding to said received digital signature.

12. The method of claim 8 wherein the generated key corresponds to name data and the retrieval includes:
retrieving a plurality of data records corresponding to the generated key; and
comparing the biometric data stored in the retrieved data records to other biometric data received from a merchant purchase site.

13. A method for accessing a financial account of a consumer comprising:
capturing biometric data corresponding to a consumer; and
sending the captured biometric data to a merchant payment host to obtain financial account data from the merchant payment host.

14. The method of claim 13 further comprising:
generating a digital signature from the captured biometric data; and
transmitting the generated signature in a transaction message to the merchant payment host for authorizing generation of electronic transfer messages by the merchant payment host.
